(19) United States
(12) Patent Application Publication
(10) Pub. No.: US 2017/0175048 A1
(43) Pub. Date: Jun. 22, 2017

(54) ACYLHYDRAZONE GRANULATE WITH TWO - LAYER COATING FOR USE IN LAUNDRY DETERGENTS

(71) Applicants: BASF SE, Ludwigshafen (DE); Henkel AG & Co, KGaA, Düsseldorf (DE)

(72) Inventors: Ullrich MENGE, Grenzach (DE); André HAETZELT, Düsseldorf (DE); Bernd LARSON, Erkelenz (DE)

(21) Appl. No.: 15/308,768

(22) PCT Filed: May 6, 2015
(86) PCT No.: PCT/EP2015/059944

§ 371 Date: Nov. 3, 2016

(30) Foreign Application Priority Data
May 9, 2014 (EP) 14167700.5

(51) Int. Cl. C11D 3/39; C11D 1/04; C11D 3/22; C11D 17/00; C11D 3/20

(52) U.S. Cl. CPC C11D 3/3917; C11D 17/0039; C11D 3/39; C11D 3/20; C11D 3/22; C11D 1/04

(57) ABSTRACT

The invention relates to a granulate of a particular bleach catalyst i. e. an acylhydrazone compound. The granulate contains a specific two-layer coating and is useful as bleach catalyst in powder detergents. Further aspects of the invention are the preparation of the granulate and a washing or bleaching formulation containing the granulate.

The instant invention relates to a granulate of a particular bleach catalyst i. e. an acylhydrazone compound. The granulate contains a specific two-layer coating and is useful as bleach catalyst in powder detergents. Further aspects of the invention are the preparation of the granulate and a washing or bleaching formulation containing the granulate.

### BACKGROUND OF THE INVENTION

The search for efficient bleach catalysis has been the object of research since a long time. WO 2012/080088 discloses a new class of catalysts, namely specific acylhydrazone compounds. These acylhydrazone compounds provide excellent bleach performance, in particular as metal free bleach catalysts. The compounds are efficient with-out a central transition metal. This is a significant difference to prior art bleach catalysts, such as, for example, described in EP 630 946, U.S. Pat. No. 5,965,506, U.S. Pat. No. 5,733,341, WO 97 19162, U.S. Pat. No. 6,486,110, U.S. Pat. No. 6,562,775, EP 955 289, WO 00 53574, WO 00 53712, WO 01 05925 and EP 02 088 289.

However, the acylhydrazones compounds disclosed in WO 2012/080088 are not easily incorporated into powder detergents. The active is water-soluble and alkaline solutions are colored (yellow). Furthermore, the alkali may induce condensation reactions of the molecule which yields colored products. This will lead to a discoloration of the detergent powder when the active material (eg. as a powder) is mixed into the detergent and stored. Granulated acylhydrazone compounds incorporated in powder detergents will turn into a yellow or brown color with time, and the detergent material in close vicinity to the catalyst granules will be discolorated, especially at humid conditions and open storage of the detergent. From a consumer perspective, this discoloration is not acceptable.

It is well known that coating the granules is a good method for solving such stability issues. As the active is water-soluble, the first approach is to apply a hydrophobic coating onto the granule surface. Wax-coatings are also an option.

For the performance of the coated granules, the properties of the coating material and the coating level must be adjusted in such a way that stability requirements in the detergents are met and at the same time the release of the active into the wash liquor is not delayed to a non-acceptable extent.

It has been the objective of the instant invention to find a coating for the acylhydrazone granules that is stable in the detergent at high humidity levels while the bleach performance of the active load is essentially maintained.

In the context of this invention the terms granulate, granule and particulate composition are used as synonyms.

### DESCRIPTION OF THE INVENTION

The objective has been solved by applying a specific two-layer coating around the granules. The core of the granule contains the acylhydrazone, and the core is coated with a specific two-layer coating comprising a water-based coating of a polymer mixture of hydroxypropylmethylcellulose (HPMC) and methylcellulose (MC), and as second coating a hydrophobic coating based on a fatty acid mixture.

One aspect of the invention is a two-layer coated granulate comprising

a) a core pellet comprising

5% to 40% by weight based on the weight of the total granule of an acylhydrazone of formula (I) and

1% to 10% by weight based on the weight of the total granule of water and/or a water soluble polymer binder which is selected from the group consisting of polyvinylalcohols, polyvinylpyrrolidones, polyacrylates, cellulose derivatives, carbohydrates, polyethyleneglycols and mixtures thereof;

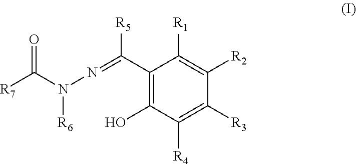

wherein

R₁, R₂, R₃, R₄ independently from each other are hydrogen, unsubstituted or substituted C₁-C₂₈alkyl, C₁-C₂₈alkoxy, C₂-C₂₈alkenyl, C₂-C₂₂alkinyl, C₃-C₁₂cycloalkyl, C₃-C₁₂cycloalkenyl, C₇-C₉aralkyl, C₃-C₂₀heteroalkyl, C₃-C₁₂cycloheteroalkyl, C₅-C₁₆heteroaralkyl, unsubstituted or substituted phenyl or napththyl, wherein the substituents for the radicals are selected from the group consisting of C₁-C₄alkyl; C₁-C₄alkoxy; hydroxy; sulfo; sulfato; halogen; cyano; nitro; carboxy; amino; N-mono- or N,N-di-C₁-C₄alkylamino unsubstituted or substituted by hydroxy in the alkyl moiety; N-phenylamino; N-naphthylamino wherein the amino groups may be quaternised; phenyl; phenoxy or naphthyloxy;

or R₁, R₂, R₃, R₄ independently from each other are OR₁₁, NR₁₁R₁₂, NO₂ or halogen;

or

R₁ and R₂, R₂ and R₃ or R₃ and R₄ are linked together to form 1, 2 or 3 carbocyclic or heterocyclic rings, which may be uninterrupted or interrupted by one or more —O—, —S— or —NR₁₃— and or which may be further fused with other aromatic rings and/or which may be substituted with one or more C₁-C₆akyl groups;

R₅ denotes hydrogen, unsubstituted or substituted C₁-C₂₈alkyl, C₂-C₂₈alkenyl, C₂-C₂₂alkinyl, C₃-C₁₂cycloalkyl, C₃-C₁₂cycloalkenyl, C₇-C₉aralkyl, C₃-C₂₀heteroalkyl, C₃-C₁₂cycloheteroalkyl, C₅-C₁₆heteroaralkyl, unsubstituted or substituted phenyl, or unsubstituted or substituted heteroaryl; wherein the substituents for the radicals are selected from the group consisting of C₁-C₄alkyl; C₁-C₄alkoxy; hydroxy; sulfo; sulfato; halogen; cyano; nitro; carboxy; amino; N-mono- or N,N-di-C₁-C₄alkylamino unsubstituted or substituted by hydroxy in the alkyl moiety; N-phenylamino; N-naphthylamino wherein the amino groups may be quaternised; phenyl; phenoxy or naphthyloxy;

R₆ denotes hydrogen, C₁-C₂₈alkyl, C₂-C₂₈alkenyl, C₂-C₂₂alkinyl, C₃-C₁₂cycloalkyl, C₃-C₁₂cycloalkenyl, C₇-C₉aralkyl, C₃-C₂₀heteroalkyl, C₃-C₁₂cycloheteroalkyl, C₅-C₁₆heteroaralkyl, unsubstituted or substituted phenyl or naphtyl, or unsubstituted or substituted heteroaryl; wherein the substituents for the radicals are selected from the group consisting of C₁-C₄alkyl; C₁-C₄alkoxy; hydroxy; sulfo; sulfato; halogen; cyano; nitro; carboxy; amino; N-mono- or N,N-di-C₁-C₄alkylamino unsubstituted or substituted by hydroxy in the alkyl moiety; N-phenylamino; N-naphthylamino wherein the amino groups may be quaternised; phenyl; phenoxy or naphthyloxy;

R₇ is a group

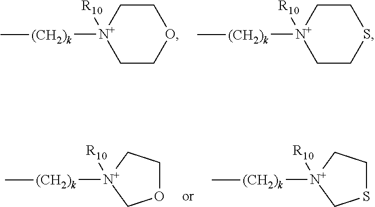

each group with an anion A³¹ ;

k is an integer from 1 to 4;

A⁻ is the anion of an organic or inorganic acid;

R₁₀ denotes hydrogen, C₁-C₂₈alkyl, C₂-C₂₈alkenyl, C₂-C₂₂alkinyl, C₃-C₁₂cycloalkyl, C₃-C₁₂cycloalkenyl, C₇-C₇aralkyl, C₃-C₂₀heteroalkyl, C₃-C₁₂cycloheteroalkyl, C₅-C₁₆heteroaralkyl;

R₁₁, R₁₂ independently are hydrogen, C₁-C₁₈alkyl or phenyl; or R₁₁ and R₁₂ together with the nitrogen atom to which they are bonded form a 5 or 6 membered-ring which may contain a further N, O or S atom.

R₁₃ denotes hydrogen or C₁-C₁₈alkyl;

b) 0.1% to 25% by weight based on the weight of the total granule of a subcoating comprising a polymer mixture of hydroxypropylmethylcellulose (HPMC) and methylcellulose (MC), preferably in a ratio by weight of from 2:1 to 8:1;

c) 1% to 20% by weight based on the weight of the total granule of a topcoating comprising a fatty acid selected from nonadecanoic acid, stearic acid, palmitic acid, myristic acid and mixtures thereof, preferably comprising a mixture of stearic acid and palmitic acid, further preferably in a ratio by weight of from from 1:1 to 4:1; and

d) other ingredients

the sum of components a) to d) adding to 100%.

The pellet core is obtained by granulating the active component with a binder and optional fillers, processing aids, buffer salts, and pigment dyes or other dyes. For the binder, aqueous solutions of said water-soluble polymers may be used. However, also water alone may be used as a binder, e.g. in a powder compaction process. Several technologies can be used for granulation, e.g. drum granulation, high shear mixer granulation, spray granulation in a fluid bed or spouting bed, wet extrusion or pelletizing. After granule formation, the material normally is dried eg. in a fluid bed dryer and then screened to remove the undersize/oversize material which is then recycled in the granulation process.

The binder of the core pellet, if is not water alone, must be water-soluble and should either have a melting point (m.p.) of from 30 to 120° C., preferably from 35 to 100° C., and especially from 38 to 90° C., or have a glass transition temperature of from 30 to 120° C., preferably from 35 to 100° C., and especially from 38 to 90° C.

In general, the following are preferred: polyethylene glycols having a molecular weight of from 2000 to 20 000, polyethylene oxides having a molecular weight of from 100 000 to 1 000 000; copolymers of ethylene oxide and propylene oxides having a molecular weight of >3 500; copolymers of vinylpyrrolidone with vinyl acetate; polyvinylpyrrolidones having a molecular weight of <20 000; copolymers of ethyl acrylate and methacrylate and methacrylic acid (ammonium salt); hydroxypropyl methylcellulose phthalate; polyvinyl alcohol, and also hydroxypropyl methylcellulose. In the form of melts, such mixtures are of low viscosity and are advantageously able to be processed.

The acylhydrazones of formula (I) and their preparation are described in WO 2012/080088. These compounds are the active bleach catalysts in the final granulate,

The final two—layer coated granulate preferably has an average particle size (X₅₀) of 400 μm to 1500 μm.

The prepared core pellets are, if necessary, made round in a rounder (spheronizer) in order to remove any sharp, friable edges, and then dried (when aqueous methods are used).

The core granule particles are then coated with a first layer also called subcoating, preferably in a fluid bed or spouting bed coater. The polymer mixture of hydroxypropylmethylcellulose (HPMC) and methylcellulose (MC) preferably is dissolved in water and is then sprayed onto the granules.

Preferably the water based coating when applied contains at least 70% of HPMC and MC in a weight ratio of from 2:1 to 8:1.

Specifically, the HPMC and MC grades are of low mol weight, and the HPMC is a mixture of HPMC 3 and HPMC 6, preferably a mixture of 1:1 by weight.

HPMC and MC are nonionic cellulose ethers which are used in many different application fields. Chemically, part of the hydroxyl groups in the anhydroglucose units that build natural cellulose are substituted with methoxy groups in the case of MC, and both methoxy and hydroxypropoxy groups for the HPMC. A common way to designate the average level of substitution on the cellulose chain is to give the methoxyl content and the hydroxypropyl content in the product in wt-%. Both substitution levels and also the degree of polymerization have influence on the properties of the product.

A commercial MC may have about 28 -30 wt-% of methoxy group content, and a commercial HPMC may have about 28-30 wt-% of methoxy group content and 7-12 wt-% of hydroxypropoxy group content. For coating purpose, low degree of polymerization is preferred in order to achieve low viscosity of the coating solution which is sprayed on the granules. Typically, the viscosity at 2,0 wt-%, in mPas is also displayed in the product description.

As an example, Tylose MOBS 3 P4 (Shin Etsu) is a product with methoxy group content of 28-30%, a hydroxypropoxy group content of 7-12%, and a viscosity within 2.4 -3.6 mPas of a 2 wt-% solution in water at 20° C., measured with an Ubbelohde viscosimeter at 20° C.”

When the subcoating process is complete, the molten fatty acid mixture is coated on the granules via melt coating technology, to give a second coating layer, also called topcoating. Optionally, a small amount of silica is added into the fluid bed after the melt coating is completed, to improve the flowability of the product.

Preferably the mixture contains more than 60% stearic acid. In a specific embodiment the mixture contains 75% stearic acid and 25% palmitic acid.

The final coated granules according to the invention may be white/off-white, or colored. In case of a colored granule, the dye may be located in the granule core and/or in any of the coating layers.

Other ingredients mean formulation aids or additives and fillers for the granule core. That means these materials may be either useful for granulating the core pellet of the granule, and/or add an additional benefit in the laundry, and/or may serve as a filler, e.g. to enable a specific acylhydrazone content in the final product.

Among the preferred materials are those:

that are useful for pelletizing the core pellet, e.g. starch, modified starch, microcrystalline cellulose, calcium sulphate and so on, while it is understood in the context of the invention that these materials are not regarded as binders as specified above; and/or those that are used as typical filler material in detergent compositions, eg. sodium sulphate, sodium chloride and the like;

and/or those that are used as a detergent ingredient and have some functionality in the laundry process beyond simply being a filler material, e.g. sodium silicates, zeolithes, phosphates, buffer materials like citrates, disperging agents or suspending agents;

and/or inorganic material for increasing the whiteness of the granule core, e.g. titan dioxide.

In a specific embodiment the core pellet, the subcoating or the topcoating additionally comprises

0% to 1% by weight based on the weight of the total granule of at least one dye or pigment or a mixture thereof.

For instance the granule comprises 0% to 2% by weight based on the weight of the total granule of a hydrophobic fine-particulate material.

The hydrophobic fine particulate material is, for example silica.

For example the compound of formula (1) is

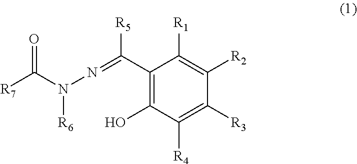

wherein

R₁, R₂, R₃, R₄ independently from each other are hydrogen, C₁-C₆alkyl, Cₗ-C₈alkoxy, halogen, OR₁₁ or NR₁₁R₁₂;

R₅ denotes hydrogen or C₁-C-C₁₆alkyl;

R₆ denotes hydrogen or C₁-C₁₈alkyl;

R₇ is a group

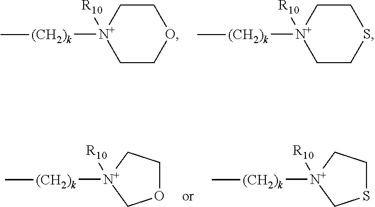

each group with an anion A⁻;

k is an integer from 1 to 4;

A⁻ is the anion of an organic or inorganic acid;

R₁₀ denotes hydrogen or C₁-C₁₈alkyl,;

R₁₁, R₁₂ independently are hydrogen, C₁-C₁₈alkyl or phenyl;

R₁₃ denotes hydrogen or C₁-C₄alkyl.

For instance in the compound of formula (1)

R₁, R₂, R₃, R₄ independently from each other are hydrogen, OH, methoxy, halogen or methyl;

R₅ denotes hydrogen or methyl;

R₆ denotes hydrogen or methyl;

R₇ is a group

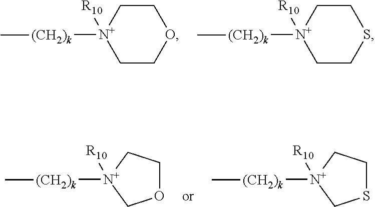

each group with an anion A⁻;

k is an integer from 1 to 2;

A⁻ is the anion of an organic or inorganic acid;

R₁₀ denotes hydrogen or C₁-C₄alkyl.

Preferably in the compound of formula (1)

R₁, R₂, R₃, R₄ independently from each other are hydrogen, OH, or methyl;

R₅ denotes hydrogen;

R₆ denotes hydrogen;

R₇ is a group

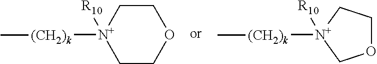

each group with an anion A⁻;

k is 1;

A⁻ is is the anion of an organic or inorganic acid;

R₁₀ denotes methyl.

More preferably in the compound of formula (1)

R₁, R₂, R₃, R₄ are hydrogen;

R₅ denotes hydrogen;

R₆ denotes hydrogen;

R₇ is a group

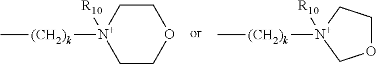

each group with an anion A⁻;

k is 1;

A⁻ is Cl⁻ or Br⁻;

R₁₀ denotes methyl.

Specific suitable compounds are

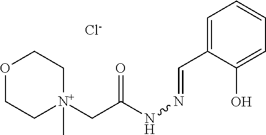 [SMILES: C[N+]1(CC(=O)NN=Cc2ccccc2O)CCOCC1 ; [Cl-]]

Typically the subcoating is present in an amount of from 0.4% to 12% by weight based on the weight of the total granule.

For example, the topcoating is present in an amount of from 3% to 15% by weight based on the weight of the total granule.

Another aspect of the invention is a method of preparing a two-layer coated granulate as described above wherein the ingredients of the core pellet component (a) of claim 1 are first of all granulated; the granulated core pellet is then coated in a first step with 0.1% to 25% by weight based on the weight of the total granule of a subcoating comprising a polymer mixture of hydroxypropylmethylcellulose (HPMC) and methylcellulose (MC), preferably in a ratio by weight of from 2:1 to 8:1 and in a second step coated with 1% to 20% by weight based on the weight of the total granule of a topcoating comprising a mixture of stearic acid and palmitic acid in a ratio by weight of from from 1:1 to 4:1.

Also an aspect of the invention is the use of a granulate as described above together with a peroxy compound for bleaching stains or soiling on textile material in the context of a washing process.

The washing process may be at a temperature between 20° C. and 95° C, preferably between 20° C. and 60° C. The washing process is preferably carried out in an automatic washing machine.

Yet a further aspect of the invention is a washing, cleaning or bleaching composition comprising a granulate as described above in an amount that gives a bleach catalyst concentration in the liquor of from 0.05 to 100 mg/l of liquor, preferably from 0.05 to 50 mg/l of liquor, more preferably from 0.05 to 30 mg/l of liquor when from 0.5 to 20 g/l of the washing, cleaning or bleaching composition are added to the liquor, and common ingredients of washing, cleaning or bleaching compositions compatible with said granulate.

The compositions may for example comprise from 0 to 50% by weight, preferably from 0 to 30% by weight, A) of at least one anionic surfactant and/or B) of at least one nonionic surfactant,

from 0 to 70% by weight, preferably from 0 to 50% by weight, C) of at least one builder substance,

from 1 to 99% by weight, preferably from 1 to 50% by weight, D) of at least one peroxide or at least one peroxide-forming substance.

The anionic surfactant A) can be, for example, a sulfate, sulfonate or carboxylate surfactant or a mixture thereof. Preferred sulfates are those having from 12 to 22 carbon atoms in the alkyl radical, optionally in combination with alkylethoxysulfates having from 10 to 20 carbon atoms in the alkyl radical.

Preferred sulfonates are, for example, alkylbenzenesulfonates having from 9 to 15 carbon atoms in the alkyl radical. The cation in the anionic surfactants is preferably an alkali metal cation, especially sodium.

Preferred carboxylates are alkali metal sarcosinates of formula R₅₀—CO—N(R₅₁)—CH₂COOM′₁, wherein

R₅₀ is alkyl or alkenyl having from 8 to 18 carbon atoms in the alkyl or alkenyl radical,

R₅₁ is C₁-C₄alkyl and

M′₁ is an alkali metal.

The non-ionic surfactant B) may be, for example, a primary or secondary alcohol ethoxylate, especially a C₈-C₂₀ aliphatic alcohol ethoxylated with an average of from 1 to 20 mol of ethylene oxide per alcohol group.

Preference is given to primary and secondary C₁₀-C₁₅ aliphatic alcohols ethoxylated with an average of from 1 to 10 mol of ethylene oxide per alcohol group.

Non-ethoxylated non-ionic surfactants, for example alkylpolyglycosides, glycerol monoethers and polyhydroxyamides (glucamide), may likewise be used.

When the compositions according to the invention contain a component C), the amount thereof is preferably from 1 to 70% by weight, and especially from 1 to 50% by weight, based on the total weight of the washing composition. Special preference is given to an amount of from 5 to 50% by weight and more especially an amount of from 10 to 50% by weight.

As builder substance C) there come into consideration, for example, alkali metal phosphates, especially tripolyphosphates, carbonates and hydrogen carbonates, especially their sodium salts, silicates, aluminum silicates, polycarboxylates, polycarboxylic acids, organic phosphonates, aminoalkylenepoly(alkylenephosphonate(s)) and mixtures of such compounds.

Silicates that are especially suitable are sodium salts of crystalline layered silicates of the formula NaHSiₜO₂ₜ₊₁.pH₂O or Na₂SiₜO₂ₜ₊.pH₂O wherein t is a number from 1.9 to 4 and p is a number from 0 to 20.

Among the aluminum silicates, preference is given to those commercially available under the names zeolite A, B, X and HS, and also to mixtures comprising two or more such components.

Among the polycarboxylates, preference is given to polyhydroxycarboxylates, especially citrates, and acrylates, and also to copolymers thereof with maleic anhydride. Preferred polycarboxylic acids are nitrilotriacetic acid, ethylenediaminetetraacetic acid and ethylenediamine disuccinate either in racemic form or in the enantiomerically pure (S,S) form.

Phosphonates or aminoalkylenepoly(alkylenephosphonate(s)) that are especially suitable are alkali metal salts of 1-hydroxyethane-1,1-diphosphonic acid, nitrilotris (methylenephosphonic acid), ethylenediaminetetramethylenephosphonic acid and diethylenetriaminepentamethylenephosphonic acid.

As peroxide component D) there come into consideration, for example, the organic and inorganic peroxides known in the literature and obtainable commercially that bleach textile materials at conventional washing temperatures, for example at from 10 to 95° C.

The organic peroxides are, for example, mono- or poly-peroxides, especially organic peracids or salts thereof, such as phthalimidoperoxycaproic acid, peroxybenzoic acid, diperoxydodecanoic diacid, diperoxynonanoic diacid, diperoxydecanoic diacid, diperoxyphthalic acid or salts thereof.

Preferably, however, inorganic peroxides are used, for example persulfates, perborates, percarbonates and/or persilicates. It will be understood that mixtures of inorganic and/or organic peroxides can also be used. The peroxides may be in a variety of crystalline forms and have different water contents, and they may also be used together with other inorganic or organic compounds in order to improve their storage stability.

The peroxides are added to the composition preferably by mixing the components, for example using a screw metering system and/or a fluidised bed mixer.

In addition to the peroxides bleach activators may be present. Customary bleach activators are polyacylated alkylenediamines, especially tetraacetylethylenediamine (TAED), acylated glycolurils, especially tetraacetylglycoluril (TAGU), N,N-diacetyl-N,N-dimethylurea (DDU), acylated triazine derivatives, especially 1,5-diacetyl-2,4-dioxohexahydro-1,3,5-triazine (DADHT) as well as compounds of formula (8):

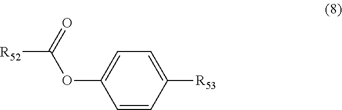

wherein

R₅₂ is a sulfonate group, a carboxylic acid group or a carboxylate group and

R₅₃ is linear or branched C₇-C₁₅alkyl.

Special activators are known under the names SNOBS, SLOBS and DOBA, acylated polyhydric alcohols, especially triacetin, ethylene glycol diacetate and 2,5-diacetoxy-2,5-dihydrofuran and also acetylated sorbitol and mannitol and acylated sugar derivatives, especially pentaacetylglucose (PAG), sucrose polyacetate (SUPA), pentaacetylfructose, tetraacetylxylose and octaacetyllactose as well as acetylated, optionally N-alkylated glucamine and gluconolactone. Combinations of conventional bleach activators, known from German Patent Application DE-A-44 43 177 can also be used.

The compositions may comprise, in addition to the combination according to the invention, one or more optical brighteners, for example from the classes of bis-triazinylamino-stilbenedisulfonic acid, bis-triazolyl-stilbenedisulfonic acid, bis-styryl-biphenyl or bis-benzofuranylbiphenyl, a bis-benzoxalyl derivative, bis-benzimidazolyl derivative or coumarin derivative or a pyrazoline derivative.

The compositions may furthermore comprise dirt-suspending agents, for example sodium carboxymethylcellulose; pH regulators, for example alkali metal or alkaline earth metal silicates; foam regulators, for example soap; salts for adjusting the spray drying and the granulating properties, for example sodium sulfate; fragrances; antistatic agents; fabric conditioners; enzymes, such as amylase, protease, cellulase and lipase; further bleaching agents; pigments; and/or toning agents. These constituents should especially be stable to the bleaching agent employed.

Definitions and preferences where applicable apply equally for all aspects of the invention.

The following Examples serve to illustrate the invention. Parts and percentages relate to weight, unless otherwise indicated.

### EXAMPLES

A) Pelletizing:

### Example E1

In a mixer, 1450 g acyl hydrazone powder, compound 101A of WO 2012/080088 is dry-blended with 1020 g of Arbocel B 600 (powder cellulose, JRS), 1560 g of corn starch (Cargill), 560 g Heweten 101 (microcrystalline cellulose, JRS) and 900 g of calcium sulphate Dihydrate (Azelis). The powder mixture is granulated with a solution of 470 g Pluriol E 8000 (BASF), 14 g of sodium hydrogen citrate (Fluka) and 14 g of citric acid (Fluka) in 2300 g of tap water which is dosed into the mixer within 65 minutes. The resulting wet mixture is granulated in a dome extruder (Fuji-Paudal, screen 1 mm) and the collected material is spheronized in a marumerizer (QJ-230T, LCI) operated at 600 rpm for 1 minute.

The pellets are dried in a fluid bed dryer at 68° C. inlet air temperature for 52 minutes. The product temperature is 31 -50° C. Residual moisture of the pellets after drying is 6.6 wt-%, as measured using an IR balance. The product is screened, and the sieve cut 400 -1500 μm is taken for further coating experiments.

### Example E2-E4

Examples E2-E4 are prepared in analogy to Example E1, but with the following proportions of compounds:

| Material | E2 | E3 | E4 |
|---|---|---|---|
| Arbocel B 800 [g] | 3480 | 4500 | 2770 |
| Corn starch [g] | 4250 | 4260 | 2110 |
| Ca-sulphate Dihydrate [g] | 5800 | — | 1750 |
| Heweten 101 [g] | — | 7120 | 3900 |
| Acylhydrazone [g] | 4700 | 9260 | 3960 |
| Compound 101A of | | | |
| WO2012/080088 | | | |
| Citric Acid/sodium citrate | 90 | 257 | 76 |
| [g] | | | |
| Pluriol E 8000 [g] | 1530 | 1970 | 1290 |
| Res. moisture after drying | 8.6 | 7.2 | 5.4 |
| step [wt-%] | | | |

B) Applying the Subcoat and Top Coat on Core Pellets:

### Example E5

Coating of core pellet with HPMC/MC/dye subcoat and fatty acid top coat

Subcoating the Pellets HPMC/MC Mixture:

For preparation of the subcoat coating solution, 68.2 g of Tylose MOBS 3 P4 and 68.2 g of Tylose MOBS 6 P4 (Hydroxypropyl Methylcellulose, ShinEtsu) are blended with 34.1 g of Benecel A 15 (Methylcellulose, Ashland). The powder mixture is disperged in 1000 g of hot water, and then diluted with 565 g cold water while continuous stirring. 3.4 g of Puricolor Blau PBL 15-L is finally stirred into the clear polymer solution. The solid content of the coating solution is 10.1%.

2000 g of Core Pellets from Example E3 are introduced into a STREA-1 laboratory fluid bed (Aeromatic-Fielder). After fluidisation of the pellets, 1739 g of the coating solution is sprayed onto the pellets within 160 minutes. Inlet air temperature is 60° C., and product temperature is about 40° C. When spraying of the coating solution is finished, the heating of the inlet air is turned off, and the pellets are cooled down until the product temperature is about 30° C. After screening the pellets, 2150 g of subcoated pellets are obtained.

The coating level of the intermediate product is 8% by weight.

Top Coating of the Subcoated Pellets with Fatty Acid Mixture

1200 g of Edenor C 18 98-100 GS (stearic acid, from Emery) and 400 g of Edenor C 16 98-100 GS (palmitic acid, from Emery) are mixed and heated to 105° C. The mixture melts in the range of 58 -68° C.

2070 g of subcoated pellets are introduced into a GCPG-1 (Glatt) equipped with hot melt technology. 282 g of the fatty acid blend is sprayed onto the pellets within 25 minutes. Air inlet temperature is in the range of 41-47° C., product temperature is in the range of 35-44° C. After the hot melt coating is finished, the pellets are cooled down to 35° C. and then removed and screened over 400 -2000 μm.

The level of fatty acid of the final product is 12% by weight.

### Examples E6-E11

According to the procedure described in example E5, the following products are obtained. In case E6-E8, only the fatty acid coating is applied (comparative examples) In example E9 the Puricolor dye is omitted from the subcoat solution:

| | E6 | E7 | E8 | | | |
|---|---|---|---|---|---|---|
| Sample | comp. | comp. | comp. | E9 | E10 | E11 |
| Core pellet example | E3 | E3 | E3 | E3 | E3 | E3 |
| Subcoat level [wt-%] | none | none | none | 8 | 7 | 10 |
| Modification subcoat | | | | no dye | | |
| Topcoat level [wt-%] | 15 | 25 | 30 | 12 | 12 | 12 |

Subcoat and topcoat wt-% level refer to the final product.

C) Application Test: Stability of Coated Acylhydrazone Pellets in a Detergent:

180 g of standard detergent ECE 98 (available at WFK Testgewebe GmbH, Christinenfeld 10, 41379 Brüggen-Bracht, Germany) are mixed with 20 g of sodium percarbonate granules (Fluka) in a turbula mixer.

0.20 g of the coated pellet is mixed with 19.8 g of ECE 98 containing 10% percarbonate. The mixture is homogenized using the turbula for 1 minute, and then transferred into a petridish. The petridish is stored open in a test chamber (KBF 115, Binder) at a constant climate of 35° C. and 80% r.h.

After the indicated storage time, the petridishes are removed from the test chamber and the samples are visually evaluated on discolored particles (number of particles, and colour).

TABLE 1
Stability Results

| | | E6 | E7 | E8 | | | |
|---|---|---|---|---|---|---|---|
| Sample | E5 | comp. | comp. | comp. | E9 | E10 | E11 |
| Subcoat level [wt-%] | 8 | none | none | none | 8 | 7 | 1.0 |
| Topcoat level [wt-%] | 12 | 15 | 25 | 30 | 12 | 12 | 12 |
| number (colour) of | | | | | | | |
| discolored particles: | | | | | | | |
| after 3 days | none | 20 | (yellow) | (yellow) | none | none | none |
| 35° C.@80% r.h. | | (yellow) | | | | | |
| after 7 days | 2 | 50 | 15 | 3 | 1 | none | 1 |
| 35° C.@80% r.h. | (blue- | (yellow, | (yellow, | (yellow) | (brown) | | (blue- |
| | green) | brown) | brown) | | | | green) |

The results clearly indicate that with a fatty acid coating and no subcoat even at high coating levels the stability is not sufficient, whereas the granulate with both coatings exhibits sufficient stability.

### Application Example 1

### Bleach Performance

10 g of white cotton fabric and 0.5 g BC03 (tea stain) on cotton fabric are treated in 250 ml of washing liquor. The liquor contains AATCC standard detergent (available at WFK Testgewebe GmbH, Christinenfeld 10, 41379 Brüggen-Bracht, Germany) in a concentration of 3.8 g/l, 0.660 g/l sodium percarbonate (SPC), 0.164 mg/l TAED. The catalyst granules added result in a catalyst concentration of 20 μmol/l after complete dissolution of the respective granule. The washing process is carried out in a steel beaker in a LINITEST apparatus for 60 minutes at 20° C. For evaluating the bleaching results, the increase in the lightness DY (difference in lightness according to CIE) of the stains brought about by the treatment is determined spectrophotometrically. The higher the ΔY value, the better the bleach performance.

TABLE 2
Stain Removing Results

| Sample | E5 | E6 | E7 | E8 | E9 | E10 | E11 | E12 |
|---|---|---|---|---|---|---|---|---|
| Subcoat level [wt-%] | 6 | none | none | none | 8 | 7 | 10 | no |
| Topcoat level [wt-%] | 12 | 15 | 25 | 30 | 12 | 12 | 12 | catalyst |
| ΔY BC03 Tea stain | 10.1 | 9.2 | 7.1 | 6.8 | 10 | 9.6 | 9.6 | 6.6 |

Samples E6 to E8 and E12 are comparative examples. E12 contains no bleach catalyst.

The results indicate that the inventive granules provide for a significant bleach boost.

### Application Example 2

### Catalyst Release

An amount of catalyst granules that contains 225 mg of active catalyst is stirred in 1 L 25 mM carbonate buffer pH10.0 containing 350 mg/l CuSO4×5H₂O (room temperature). At different points of time samples were taken, filtered and the UV absorption was taken at 370 nm as a measure for the amount of catalyst released into the buffer solution. The following table indicates the ratio of catalyst released at selected test points of the release experiment.

TABLE 3
% Catalyst released into liquor

| Sample | E6 | E7 | E8 | E9 | E10 | E11 |
|---|---|---|---|---|---|---|
| % after 20 min | 52 | 6 | 2 | 90 | 65 | 75 |
| % after 40 min | 84 | 26 | 10 | 98 | 94 | 97 |

The data clearly indicate that the inventive granulate exhibits an increased release of bleach catalyst as compared to the comparative examples E6 to E8.

1.-13. (canceled)

14. A two-layer coated granulate comprising
a) a core pellet comprising
5% to 40% by weight based on the weight of the total granule of an acylhydrazone of formula (I) and
1% to 10% by weight based on the weight of the total granule of water and/or a water soluble polymer binder which is selected from the group consisting of polyvinylalcohols, polyvinylpyrrolidones, polyacrylates, cellulose derivatives, carbohydrates, polyethyleneglycols and mixtures thereof; 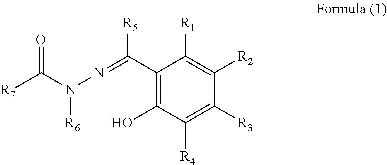
wherein
R₁, R₂, R₃, R₄ independently from each other are hydrogen, unsubstituted or substituted C₁-C₂₈alkyl, C₁-C₂₈alkoxy, C₂-C₂₈alkenyl, C₂-C₂₂alkinyl, C₃-C₁₂cycloalkyl, C₃-C₁₂cycloalkenyl, C₇-C₉aralkyl, C₃-C₂₀heteroalkyl, C₃-C₁₂cycloheteroalkyl, C₅-C₁₆heteroaralkyl, unsubstituted or substituted phenyl or naphthyl, wherein the substituents for the radicals are selected from the group consisting of C₁-C₄alkyl; C₁-C₄alkoxy; hydroxy; sulfo; sulfato; halogen; cyano; nitro; carboxy; amino; N-mono- or N,N-di-C₁-C₄alkylamino unsubstituted or substituted by hydroxy in the alkyl moiety; N-phenylamino; N-naphthylamino wherein the amino groups is optionally quaternized; phenyl; phenoxy or naphthyloxy;
or R₁, R₂, R₃, R₄ independently from each other are OR₁₁, NR₁₁R₁₂, NO₂ or halogen;
or
R₁ and R₂, R₂ and R₃ or R₃ and R₄ are linked together to form 1, 2 or 3 carbocyclic or heterocyclic rings, which is optionally uninterrupted or interrupted by one or more —O—, —S— or —NR₁₃— and or which is optionally further fused with other aromatic rings and/or which is optionally substituted with one or more C₁-C₆akyl groups;
R₅ denotes hydrogen, unsubstituted or substituted C₁-C₂₈alkyl, C₂-C₂₈alkenyl, C₂-C₂₂alkinyl, C₃-C₁₂cycloalkyl, C₃-C₁₂cycloalkenyl, C₇-C₉aralkyl, C₃-C₂₀heteroalkyl, C₃-C₁₂cycloheteroalkyl, C₅-C₁₆heteroaralkyl, unsubstituted or substituted phenyl, or unsubstituted or substituted heteroaryl; wherein the substituents for the radicals are selected from the group consisting of C₁-C₄alkyl; C₁-C₄alkoxy; hydroxy; sulfo; sulfato; halogen; cyano; nitro; carboxy; amino; N-mono- or N,N-di-C₁-C₄alkylamino unsubstituted or substituted by hydroxy in the alkyl moiety; N-phenylamino; N-naphthylamino wherein the amino groups is optionally quaternized; phenyl; phenoxy or naphthyloxy;
R₆ denotes hydrogen, C₁-C₂₈alkyl, C₂-C₂₈alkenyl, C₂-C₂₂alkinyl, C₃-C₁₂cycloalkyl, C₃-C₁₂cycloalkenyl, C₇-C₉aralkyl, C₃-C₂₀heteroalkyl, C₃-C₁₂cycloheteroalkyl, C₅-C₁₆heteroaralkyl, unsubstituted or substituted phenyl or naphthyl, or unsubstituted or substituted heteroaryl; wherein the substituents for the radicals are selected from the group consisting of C₁-C₄alkyl; C₁-C₄alkoxy; hydroxy; sulfo; sulfato; halogen; cyano; nitro; carboxy; amino; N-mono- or N,N-di-C₁-C₄alkylamino unsubstituted or substituted by hydroxy in the alkyl moiety; N-phenylamino; N-naphthylamino wherein the amino groups is optionally quaternized; phenyl; phenoxy or naphthyloxy;
R₇ is a group 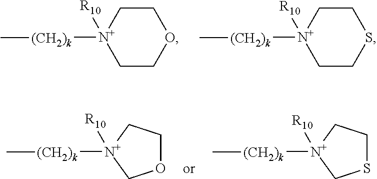
each group with an anion A⁻;
k is an integer from 1 to 4;
A³¹ is the anion of an organic or inorganic acid;
R₁₀ denotes hydrogen, C₁-C₂₈alkyl, C₂-C₂₈alkenyl, C₂-C₂₂alkinyl, C₃-C₁₂cycloalkyl, C₃-C₁₂cycloalkenyl, C₇-C₉aralkyl, C₃-C₂₀heteroalkyl, C₃-C₁₂cycloheteroalkyl, C₅-C₁₆heteroaralkyl;
R₁₁, R₁₂ independently are hydrogen, C₁-C₁₈alkyl or phenyl; or R₁₁ and R₁₂ together with the nitrogen atom to which they are bonded form a 5 or 6 membered-ring which may contain a further N, O or S atom.
R₁₃ denotes hydrogen or C₁-C₁₈alkyl;
b) 1% to 25% by weight based on the weight of the total granule of a subcoating comprising a polymer mixture of hydroxypropylmethylcellulose (HPMC) and methylcelluolose (MC) in a ratio by weight of from 2:1 to 8:1;
c) 1% to 20% by weight based on the weight of the total granule of a topcoating comprising a fatty acid selected from nonadecanoic acid, stearic acid, pahnitic acid, myristic acid and mixtures thereof; and
d) other ingredients
the sum of components a) to d) adding to 100%.

15. The two-layer coated granulate according to claim 14 wherein the core pellet, the subcoating or the topcoating additionally comprises 0% to 1% by weight based on the weight of the total granule of at least one dye or pigment or a mixture thereof.

16. The two-layer coated granulate according to claim 14 wherein the subcoating comprises the mixture of hydroxypropylmethylcellulose (HPMC) and methylcellulose (MC) in a ratio by weight of from 2:1 to 8:1 and the topcoating comprises a mixture of stearic acid and palmitic acid, in a ratio by weight of from 1:1 to 4:1.

17. The two-layer coated granulate according to claim 14 wherein the compound of formula (1) is 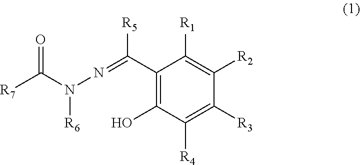
wherein
R₁, R₂, R₃, R₄ independently from each other are hydrogen, C₁-C₈alkyl, C₁-C₈alkoxy, halogen, OR₁₁ or NR₁₁R₁₂;
R₅ denotes hydrogen or C₁-C₁₈alkyl;
R₆ denotes hydrogen or C₁-C₁₈alkyl;
R₇ is a group 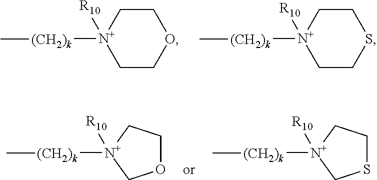
each group with an anion A⁻;
k is an integer from 1 to 4;
A⁻ is the anion of an organic or inorganic acid;
R₁₀ denotes hydrogen or C₁-C₁₈alkyl,;
R₁₁, R₁₂ independently are hydrogen, C₁-C₁₈alkyl or phenyl; and
R₁₃ denotes hydrogen or C₁-C₄alkyl.

18. The two-layer coated granulate according to claim 14 wherein in the compound of formula (1)
R₁, R₂, R₃, R₄ independently from each other are hydrogen, OH, methoxy, halogen or methyl;
R₅ denotes hydrogen or methyl;
R₆ denotes hydrogen or methyl;
R₇ is a group 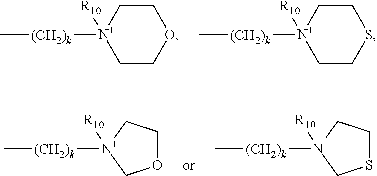
each group with an anion A⁻;
k is an integer from 1 to 2;
A⁻ is the anion of an organic or inorganic acid; and
R₁₀ denotes hydrogen or C₁-C₄alkyl.

19. The two-layer coated granulate according to claim 14 wherein in the compound of formula (1)
R₁, R₂, R₃, R₄ independently from each other are hydrogen, OH, or methyl;
R₅ denotes hydrogen;
R₆ denotes hydrogen;
R₇ is a group 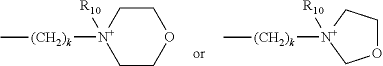
each group with an anion A⁻;
k is 1;
A⁻ is the anion of an organic or inorganic acid; and
R₁₀ denotes methyl.

20. The two-layer coated granulate according to claim 14 wherein in the compound of formula (1)
R₁, R₂, R₃, R₄ are hydrogen;
R₅ denotes hydrogen;
R₆ denotes hydrogen;
R₇ is a group 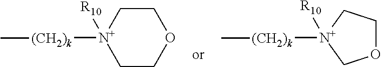
each group with an anion A⁻;
k is 1;
A⁻ is Cl⁻ or Br⁻; and
R₁₀ denotes methyl.

21. The two-layer coated granulate according to claim 14 wherein the compound of formula (1) is

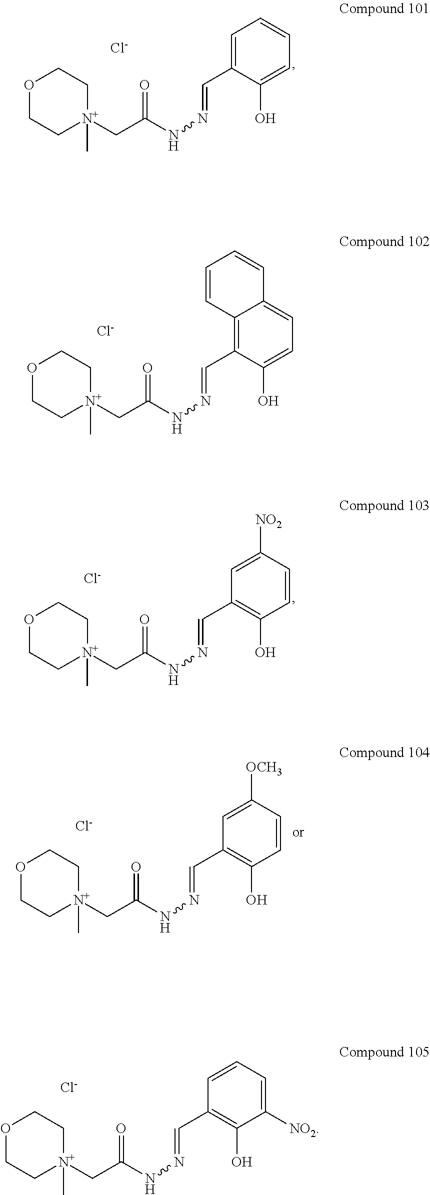

22. The two-layer coated granulate according to claim 14 wherein the subcoating is present in an amount of from 0.4% to 12% by weight based on the weight of the total granule.

23. The two-layer coated granulate according to claim 14 wherein the topcoating is present in an amount of from 3% to 15% by weight based on the weight of the total granule.

24. A method of preparing the two-layer coated granulate according to claim 14, wherein the ingredients of the core pellet component (a) of claim 14 are first of all granulated; the granulated core pellet is then coated
in a first step with 0.1% to 25% by weight based on the weight of the total granule of a subcoating comprising a polymer mixture of hydroxypropylmethylcellulose (HPMC) and methylcellulose (MC), in a ratio by weight of from 2:1 to 8:1 and
in a second step coated with 1% to 20% by weight based on the weight of the total granule of a topcoating comprising a mixture of stearic acid and palmitic acid in a ratio by weight of from from 1:1 to 4:1.

25. A process for bleaching stains or soiling on textile material which comprising contacting the material with the granulate according to claim 14 together with an peroxy compound.

26. A washing, cleaning or bleaching composition comprising
the granulate according to claim 14 in an amount that gives a bleach catalyst concentration in the liquor of from 0.05 to 100 mg/l of liquor, when from 0.5 to 20 g/l of the washing, cleaning or bleaching composition are added to the liquor, and common ingredients of washing, cleaning or bleaching compositions compatible with said granulate.

27. A washing, cleaning or bleaching composition comprising
the granulate according to claim 14 in an amount that gives a bleach catalyst concentration in the liquor of from 0.05 to 30 mg/l of liquor when from 0.5 to 20 g/l of the washing, cleaning or bleaching composition are added to the liquor, and common ingredients of washing, cleaning or bleaching compositions compatible with said granulate.
